(19) United States
(12) Patent Application Publication
(10) Pub. No.: US 2007/0057166 A1
(43) Pub. Date: Mar. 15, 2007

(54) OPTICAL MODULE

(76) Inventors: Cheng-Chung Kuo, Taipei City (TW); Ho-Feng Chiu, Taipei Hsien (TW); Jen-Chun Weng, Taipei City (TW); Chen-Hsiu Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,076

(22) Filed: Jan. 23, 2006

(30) Foreign Application Priority Data
Sep. 13, 2005 (TW) 094131517

(51) Int. Cl. G06M 7/00

(52) U.S. Cl. 250/221

(57) ABSTRACT

An optical module includes a frame, a light source module positioned at a first end of the frame, and a sensor module positioned on the frame for sensing light emitted from the light source module and reflected from a surface. The light source module includes a light source covered by a first protection element, part of the first protection element forming a lens. The sensor module includes a sensor covered by a second protection element, part of the second protection element forming a lens for focusing light reflected from the surface.

### BACKGROUND OF THE INVENTION

1. Field of the Invention

The present invention relates to an optical module, and more particularly, to an optical module of a light source module and a sensor module positioned on a frame.

2. Description of the Prior Art

Please refer to FIG. 1, which is a cross-sectional view of an optical mouse 10 according to the prior art. The optical mouse 10 comprises a light-emitting diode (LED) 12, a holder 14, a lens component 16, a lens 18, a mold 22, a sensor chip 24, a conductive frame 26 having a plurality of pins 13, an aperture 28, a printed circuit board (PCB) 30, and a base 40. A light-generating system according to the prior art is composed of the LED 12, the holder 14, and the lens component 16. An imaging system according to the prior art is composed of the lens 18 (positioned inside the lens component 16), the mold 22, the sensor chip 24, the conductive frame 26, and the aperture 28. The combination of the light-generating system and the imaging system is fixed onto the base 40.

In the light-generating system, the light-emitting diode 12 emits light L1′ toward a surface 31. The holder 14 is capable of positioning the light-emitting diode 12. With the lens component 16, the light L1′ emitted from the light-emitting diode 12 is reflected and refracted to the surface 31 with an appropriate angle, wherein the light L1′ is usually obliquely directed to the surface 31.

In the imaging system, the conductive frame 26 is capable of fixing the sensor chip 24 and providing power and signals to the sensor chip 24. The mold 22 is like a container formed by injection molding for protecting the sensor chip 24, and comprises a lower cover. An aperture 28 is formed on the lower cover, and is capable of filtering out undesirable light to improve imaging quality. In addition, the lens 18 is capable of focusing the reflected light from the surface 31 to the sensor chip 24. Images sensed by the sensor 24 are transmitted via the PCB 30 and outputted to a control component (not shown in FIG. 1) for determining in which direction and how far the optical mouse 10 moves according to the images. The PCB 30 can supply power to the sensor chip 24 and the light-emitting diode 12, and is connected to the conductive frame 26 and the holder 14 for assisting in fixing the sensor chip 24 and the light-emitting diode 12.

Please refer to FIG. 2, which is an exploded view of the optical mouse 10 of FIG. 1. The optical mouse 10 comprises all elements of FIG. 2, resulting in a complex assembly. For instance, the lens component 16 and the LED 12 must be positioned precisely so that the light emitted from the LED 12 is capable of directly traveling into the lens component 16. Furthermore, precisely positioning the lens 18 and the sensor chip 24 is very important because it will affect the sensitivity of the optical mouse 10.

### SUMMARY OF THE INVENTION

The claimed invention discloses an optical module. The optical module comprises a frame, a light source module positioned at a first end of the frame, and a sensor module positioned on the frame, for sensing light emitted from the light source module and reflected from a surface. The light source module comprises a light source covered by a protection element, part of the protection element forming a lens.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional view of an optical mouse according to the prior art.

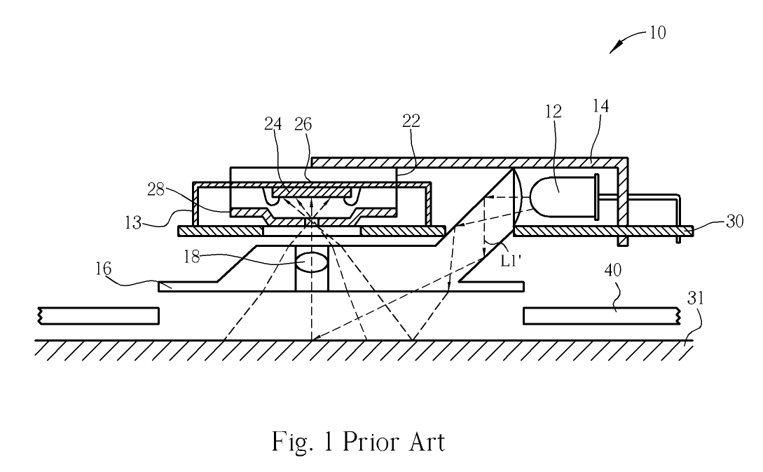

FIG. 2 is an exploded view of the optical mouse of FIG. 1.

FIG. 3 is a cross-sectional view of an optical mouse according to the present invention.

FIG. 4 is a cross-sectional view of another embodiment of an optical mouse according to the present invention.

FIG. 5 is an exploded view of the optical mouse of FIG. 3.

FIG. 6 is an exploded view of another embodiment of the optical mouse without a holder of FIG. 5.

### DETAILED DESCRIPTION

In order to solve the problem mentioned above, the present invention provides a new structure of an optical mouse.

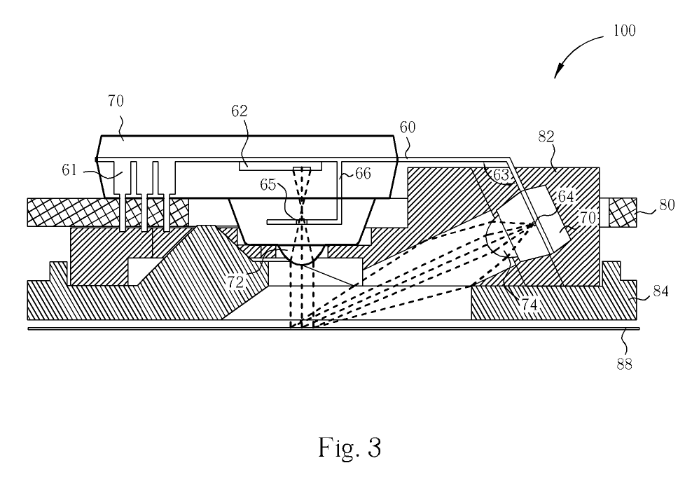

Please refer to FIG. 3, which is a cross-sectional view of an optical mouse 100 according to the present invention. There are a sensor chip 62 and a light source 64, such as a light-emitting diode (LED), positioned on a conductive frame 60 of the optical mouse 100. A part of the frame 60 between the sensor chip 62 and the light source 64 is bent to an angle 63. The details about the angle 63 are described later.

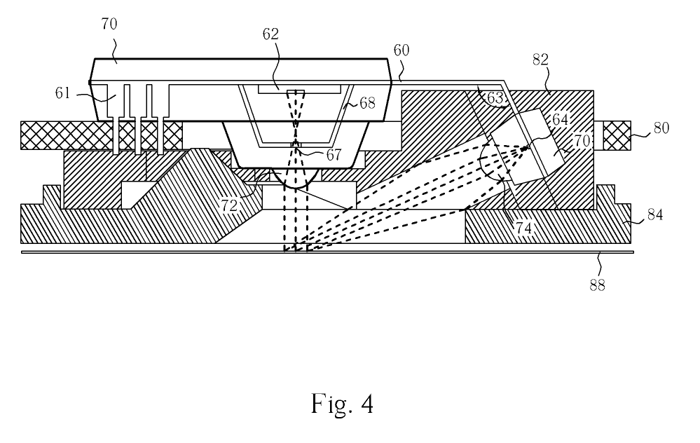

There is an aperture 65 formed on an arm 66 extended from the conductive frame 60. After the extended arm 66 is bended, the aperture 65 is over a light-sensing area of the sensor chip 62, such that focused light can be projected to the sensor chip 62. Another embodiment for the aperture is shown in FIG. 4. An aperture 67, which performs the same function as the aperture 65 of FIG. 3, formed on a cover 68 is fixed onto the conductive frame 60.

Please refer to FIG. 3 again. The sensor chip 62 and the light source 64 are covered by protection elements 70, and parts of the protection elements 70 form lenses 72, 74 respectively over the sensor chip 62 and the light source 64. The lens 74 is capable of collecting light emitted from the light source 64 and projecting light to a surface 88. The lens 72 is capable of focusing light reflected from the surface 88. The material of the protection elements 70 is epoxy, or a thermosetting compound capable of bearing high temperatures of around 265° C. If the protection element 70 is transparent epoxy, the light source 64 is selected from a group consisting of a visible light LED, such as a red, blue or green LED, or a laser diode (LD). If the protection element 70 is opaque epoxy but pervious to Infrared rays (IR), the light source 64 should be a IR LED. The embodiments of FIG. 3 and FIG. 4 use transparent epoxy, and thereby all elements inside the protection element 70 can be observed clearly. The material of the protection element 70 is not limited as above. Any material capable of protecting chips or forming a lens is compatible with the present invention.

As the light path shown in FIG. 3, the lens 74 directs light emitted from the light source 64 to the surface 88 so that the sensor chip 62 can receive more reflected light. Therefore, the angle 63 must be appropriate to ensure light refracted by the lens 74 can be projected to the surface 88 under the light-sensing area of the sensor chip 62. The angle 63 is preferably within a range of 60° and 85°.

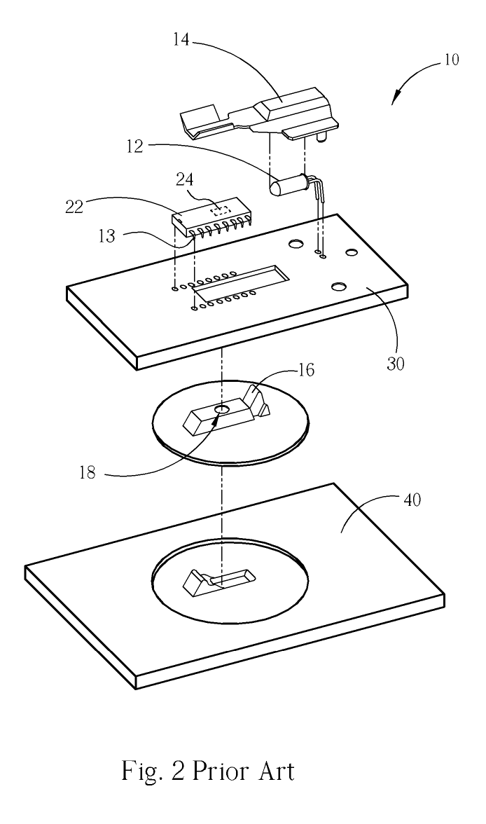

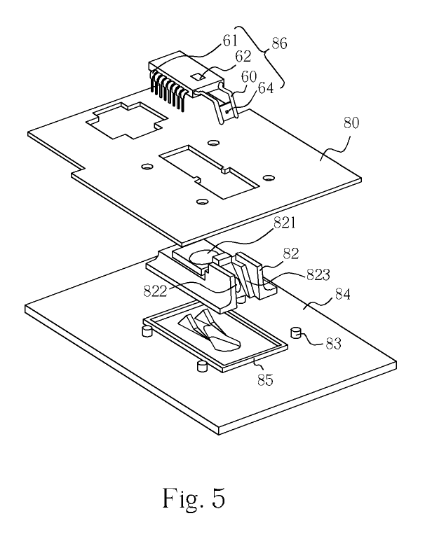

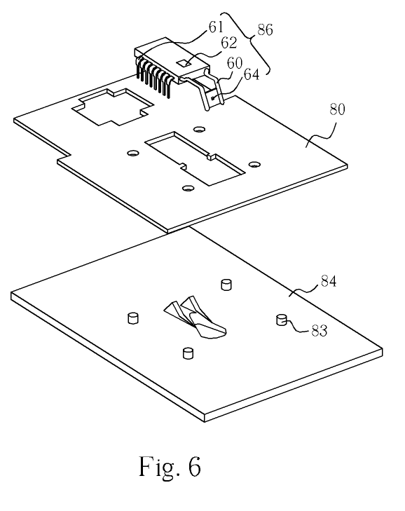

The sensor chip 62 and the light source 64 are fixed onto a printed circuit board (PCB) 80 via a plurality of pins 61 extended from the conductive frame 60. The PCB 80 is fixed on posts 83 of a base 84. A holder 82 can support the sensor chip 62 and the light source 64, filter out undesirable light, position the angle of emergence of light emitted from the light source 64, and assist in directing the light emitted from the light source 64 to the surface 88. Please refer to FIG. 5, which is an exploded view of the optical mouse 100 of FIG. 3. The holder 82 comprises two holes 821, 822, and an inclined plane 823. The holes 821, 822 respectively accommodate the lenses 72, 74, and the inclined plane 823 supports the angle 63 to prevent the angle 63 from being changed due to external force. The holder 82 is fixed inside an oblong frame 85 of the base 84. Compared to FIG. 2, assembly of the optical mouse 100 of the present invention is much easier. One need only to weld the optical combination 86 of the sensor chip 62, the light source 64, and the lenses 72, 74 on the PCB 80, and then integrate the PCB 80, the holder 82 and the base 84. Additionally, the holder 82 can be omitted as shown in FIG. 6. In FIG. 6, there is no holder, and after the optical combination 86 is welded on the PCB 80, the PCB 80 is directly fixed onto the posts 83 of the base 84.

Compared to the prior art, the present invention utilizes the protection element to overcoat the sensor chip and the light source and to form lenses, and thereby simplifies the structure of the optical mouse. In addition, the sensor chip and the LED chip are both positioned on the frame. The present invention provides a frame bent to an appropriate angle so as to position the two chips. Therefore, the present invention can simplify the assembly and solve the problem of imprecise position during assembly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical module comprising:
a frame;
a light source module positioned at a first end of the frame, the light source module comprising a light source covered by a first protection element, part of the first protection element forming a lens; and
a sensor module positioned on the frame for sensing light emitted from the light source module and reflected from a surface.

2. The optical module of claim 1, wherein the sensor module comprises a sensor chip covered by a second protection element, part of the second protection element forming a lens for focusing light reflected from the surface.

3. The optical module of claim 2, wherein the first protection element of the light source module and the second protection element of the sensor module are of epoxy.

4. The optical module of claim 1, wherein the light source is a light-emitting diode.

5. The optical module of claim 2 further comprising an aperture positioned between the sensor chip and the lens of the sensor module.

6. The optical module of claim 5, wherein the aperture is formed on an arm extended from the frame.

7. The optical module of claim 5 further comprising a cover positioned on the frame, wherein the aperture is formed on the cover.

8. The optical module of claim 1 further comprising a circuit board, the frame comprising a plurality of pins fixed on the circuit board.

9. The optical module of claim 8 further comprising a holder, the light source module and the sensor module fixed on the holder.

10. The optical module of claim 9 further comprising a base, the holder fixed on the base.

11. The optical module of claim 1, wherein the frame comprises an angle, the light source module and the sensor module positioned on opposite sides of the angle.

12. The optical module of claim 11, wherein the angle is within a range between 60 degrees and 85 degrees.

13. An optical module comprising:
a frame;
a light source module positioned at a first end of the frame; and
a sensor module positioned on the frame, the sensor module comprising a sensor chip covered by a protection element, part of the protection element forming a lens for focusing light emitted from the light source module and reflected from a surface.

14. The optical module of claim 13 further comprising an aperture positioned between the sensor chip and the lens of the sensor module.

15. The optical module of claim 14, wherein the aperture is formed on an arm extended from the frame.

16. The optical module of claim 14 further comprising a cover positioned on the frame, wherein the aperture is formed on the cover.

17. The optical module of claim 13, wherein the protection element of the sensor module is of epoxy.

18. The optical module of claim 13 further comprising a circuit board, the frame comprising a plurality of pins fixed on the circuit board.

19. The optical module of claim 18 further comprising a holder, the light source module and the sensor module fixed on the holder.

20. The optical module of claim 19 further comprising a base, the holder fixed on the base.

21. The optical module of claim 13, wherein the frame comprises an angle, the light source module and the sensor module positioned on opposite sides of the angle.

22. The optical module of claim 21, wherein the angle is within a range between 60 degrees and 85 degrees.
